(19) United States
(12) Patent Application Publication
(10) Pub. No.: US 2020/0220758 A1
(43) Pub. Date: Jul. 9, 2020

(54) COMMUNICATION METHOD USING WAVEFORM ROBUST TO FREQUENCY DISPERSION IN COMMUNICATION SYSTEM AND APPARATUS FOR THE SAME

(71) Applicant: Electronics and Telecommunications Research Institute, Daejeon (KR)

(72) Inventors: Young Jo KO, Daejeon (KR); Gi Yoon PARK, Daejeon (KR); Seung Kwon BAEK, Daejeon (KR); Woo Ram SHIN, Daejeon (KR)

(73) Assignee: Electronics and Telecommunications Research Institute, Daejeon (KR)

(21) Appl. No.: 16/575,099

(22) Filed: Sep. 18, 2019

(30) Foreign Application Priority Data
Jan. 7, 2019 (KR) 10-2019-0001573

(51) Int. Cl. H04L 27/26; G06F 17/14; H04B 1/7085; H04L 5/00

(52) U.S. Cl. CPC H04L 27/2633; G06F 17/141; H04L 5/0007; H04L 27/2613; H04B 1/7085; H04L 27/2636

(57) ABSTRACT

An operation method of a first communication node in a communication system may comprise generating a codeword by performing coding on a data stream; generating modulation symbols by performing modulation on the codeword; performing DFT on N modulation symbols among the modulation symbols by using a plurality of DFT units; mapping output symbols of each of the plurality of DFT units to a resource; and performing IFFT on the output symbols mapped to the resource by using an IFFT unit.

### CROSS-REFERENCE TO RELATED APPLICATIONS

This application claims priority to Korean Patent Application No. 10-2019-0001573 filed on Jan. 7, 2019 with the Korean Intellectual Property Office (KIPO), the entire contents of which are hereby incorporated by reference.

### BACKGROUND

### 1. Technical Field

The present disclosure relates generally to a technique for transmitting and receiving signals, and more specifically, to a technique for transmitting and receiving signals using a waveform robust to frequency dispersion.

### 2. Related Art

With the development of information and communication technology, various wireless communication technologies are being developed. Typical wireless communication technologies include long term evolution (LTE), new radio (NR), etc. defined in the 3rd generation partnership project (3GPP) standard. The LTE may be one of the fourth generation (4G) wireless communication technologies, and the NR may be one of the fifth generation (5G) wireless communication technologies.

The 5G communication system (e.g., communication system supporting the NR) using a frequency band (e.g., frequency band above 6 GHz) higher than a frequency band (e.g., frequency band below 6 GHz) of the 4G communication system as well as the frequency band of the 4G communication system is being considered for processing of wireless data which has rapidly increased since the commercialization of the 4G communication system. The 5G communication system can support Enhanced Mobile Broadband (eMBB), Ultra-Reliable and Low-Latency Communication (URLLC), and massive Machine Type Communication (mMTC).

Meanwhile, when a signal transmitted from a transmitter to a receiver in a communication system passes through a specific channel, time dispersion and/or frequency dispersion may be caused for the signal. For example, when the signal is transmitted over a multi-path, time dispersion may occur for the signal. Also, the Doppler effect may cause frequency dispersion for the signal. If time dispersion and/or frequency dispersion for the signal are caused, phase and amplitude distortions may occur for the signal received at the receiver, thereby degrading the reception performance of the signal. Therefore, there is a need for a communication method using a waveform that is robust to the time/frequency dispersion.

### SUMMARY

Accordingly, exemplary embodiments of the present disclosure provide a communication method and a communication apparatus using signals robust to frequency dispersion.

According to an exemplary embodiment of the present disclosure, an operation method of a first communication node in a communication system may comprise generating a codeword by performing coding on a data stream; generating modulation symbols by performing modulation on the codeword; performing discrete Fourier transform (DFT) on N modulation symbols among the modulation symbols by using a plurality of DFT units; mapping output symbols of each of the plurality of DFT units to a resource; and performing inverse fast Fourier transform (IFFT) on the output symbols mapped to the resource by using an IFFT unit, wherein N is a positive integer.

The N modulation symbols may be spread in a frequency axis by the plurality of DFT units, and the spreading by the plurality of DFT units may be performed in units of one or more resource blocks.

Each of the plurality of DFT units may be an N-point DFT unit.

The IFFT unit may be an M-point IFFT unit, M may be 2^{K}, N may be 2^{L}, L may be less than or equal to K, and each of M, K and L may be a positive integer.

L may be configured by a second communication node, and a signaling message indicating L may be received from the second communication node.

The N output symbols of each of the plurality of DFT units may be mapped to consecutive N subcarriers.

The output symbols of the IFFT unit may be located sequentially in a time axis.

According to another exemplary embodiment of the present disclosure, a first communication node in a communication system may comprise a coding unit generating a codeword by performing coding on a data stream; a modulation unit generating modulation symbols by performing modulation on the codeword; a plurality of discrete Fourier transform (DFT) units performing DFT on N modulation symbols among the modulation symbols; a mapper mapping output symbols of each of the plurality of DFT units to a resource; and an inverse fast Fourier transform (IFFT) unit performing IFFT on the output symbols mapped to the resource.

The N modulation symbols may be spread in a frequency axis by the plurality of DFT units, and the spreading by the plurality of DFT units may be performed in units of one or more resource blocks.

Each of the plurality of DFT units may be an N-point DFT unit.

The IFFT unit may be an M-point IFFT unit, M may be 2^{K}, N may be 2^{L}, L may be less than or equal to K, and each of M, K and L may be a positive integer.

L may be configured by a second communication node, and a signaling message indicating L may be received from the second communication node.

The N output symbols of each of the plurality of DFT units may be mapped to consecutive N subcarriers.

According to the exemplary embodiments of the present disclosure, a transmitting communication node may generate a signal based on a multi-discrete Fourier transform (DFT) spreading scheme and transmit the generated signal. In this case, interference between symbols due to frequency dispersion may be reduced. Also, signals generated based on the multi-DFT spreading scheme may be orthogonal to each other even when experiencing Doppler shifts.

A receiving communication node comprising a linear or two-dimensional antenna array may perform processing operations (e.g., beamforming signal processing operation, channel estimation operation, and demodulation operation) on signals in respective receiving directions, combine demodulation symbols in the respective receiving directions, and perform decoding on the combined demodulation symbols. According to such the reception operation, even when frequency dispersion occurs, a decrease in the reception performance can be minimized.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a first embodiment of a communication system;

FIG. 2 is a block diagram illustrating a first embodiment of a communication node constituting a communication system;

FIG. 3 is a conceptual diagram illustrating frequency dispersion according to a multi-point transmission scheme in a communication system;

FIG. 4 is a flowchart illustrating a first exemplary embodiment of a signal transmission method based on a multi-DFT spreading scheme in a communication system;

FIG. 5 is a conceptual diagram for explaining the exemplary embodiment of FIG. 4;

FIG. 6 is a conceptual diagram for explaining a first exemplary embodiment of a method of receiving a signal in a communication system;

FIG. 7 is a conceptual diagram illustrating a first exemplary embodiment of a linear antenna array included in a communication node; and

FIG. 8 is a conceptual diagram illustrating a first exemplary embodiment of a two-dimensional antenna array included in a communication node.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which embodiments of the present disclosure are applied will be described. The communication system to which the embodiments according to the present disclosure are applied is not limited to the following description, and the embodiments according to the present disclosure may be applied to various communication systems. Here, the communication system may be used in the same sense as a communication network.

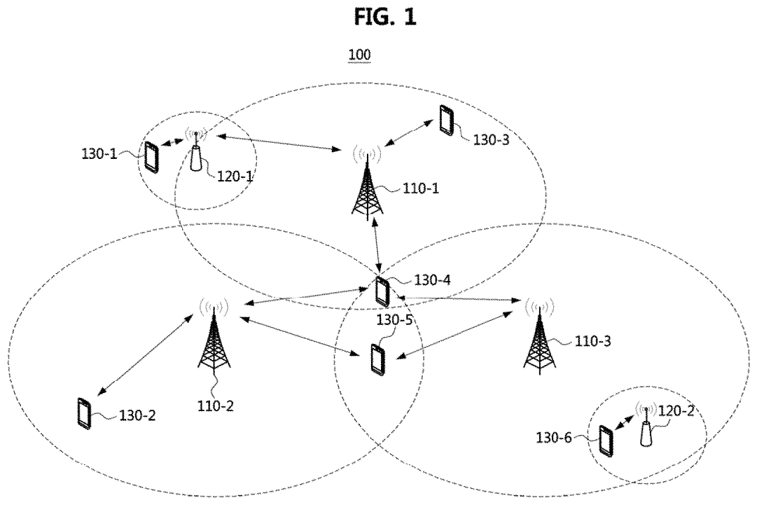

FIG. 1 is a conceptual diagram illustrating a first embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g., long term evolution (LTE), LTE-advanced (LTE-A)), 5G communication (e.g., new radio (NR)), or the like. The 4G communication may be performed in a frequency band below 6 GHz, and the 5G communication may be performed in a frequency band above 6 GHz as well as the frequency band below 6 GHz.

For example, for the 4G communication and the 5G communication, the plurality of communication nodes may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like.

Also, the communication system 100 may further comprise a core network. When the communication system supports the 4G communication, the core network may include a serving gateway (S-GW), a packet data network (PDN) gateway (P-GW), a mobility management entity (MME), and the like. When the communication system 100 supports the 5G communication, the core network may include an access and mobility management function (AMF), a user plane function (UPF), a session management function (SMF), and the like.

Meanwhile each of the plurality of communication nodes 110-1, 110-2, 110-3, 120-1, 120-2, 130-1, 130-2, 130-3, 130-4, 130-5, and 130-6 constituting the communication system 100 may have the following structure.

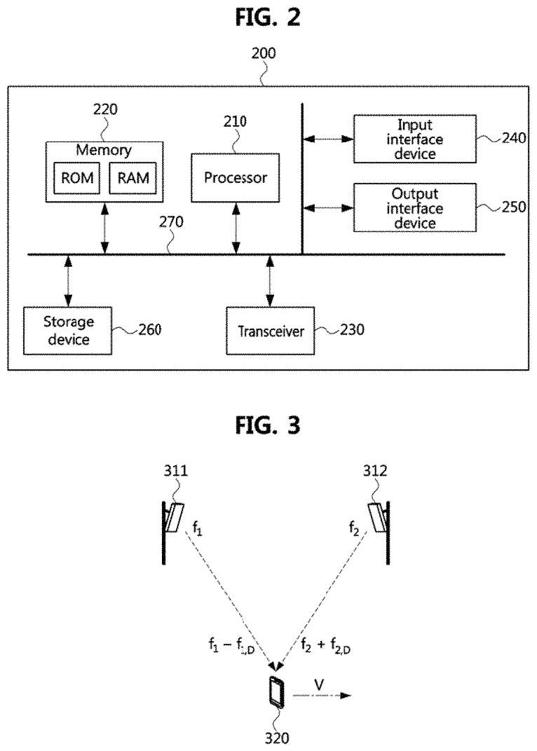

FIG. 2 is a block diagram illustrating a first embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, or the like. Also, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, communication methods using a waveform robust to frequency dispersion in a communication system will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a terminal is described, a corresponding base station may perform an operation corresponding to the operation of the terminal. Conversely, when an operation of the base station is described, the corresponding terminal may perform an operation corresponding to the operation of the base station.

Meanwhile, in a communication system, communication may be performed based on the OFDM scheme, and when the OFDM scheme is used, robust performance may be exerted for a radio channel having a multi-path. A communication node supporting the OFDM scheme may transmit a signal using a plurality of subcarriers orthogonal to each other. In order to reduce distortion of the signal by the multi-path, the communication node may transmit a signal including a cyclic prefix (CP).

Frequency dispersion may be caused by the Doppler effect in the communication system, and a radio channel environment causing the frequency dispersion may be as follows.

Fast Movement of Terminal

When a frequency of a signal is f and a moving speed of the terminal is \vec{v}, a Doppler shift f_{D} of the signal received at the terminal may be defined as in Equation 1 below.

$${f}_{D} = - \frac{\vec{v} \cdot \vec{n}}{c} f \qquad [ Equation 1 ]$$

In Equation 1, \vec{n} may be a unit vector indicating the propagation direction of the signal, c may be the speed of light (3×10⁸ m/s).

Since the signal may reach the terminal through multiple paths, the signal received at the terminal may be a sum of signals having different Doppler shift values. This phenomenon may be referred to as Doppler spread. Since the Doppler shift according to the movement of the terminal is proportional to the frequency of the signal, when the signal is transmitted using a high frequency, the Doppler shift with respect to the corresponding signal may increase. Also, when the signal passes through multiple paths, the Doppler shift with respect to the signal may increase. For example, when the frequency of the signal is 1 GHz and the moving speed of the terminal is 100 km/h, the maximum value of the Doppler shift may be 100 Hz. When the frequency of the signal is 1 THz and the moving speed of the terminal is 100 km/h, the maximum value of the Doppler shift may be 100 kHz.

The OFDM signal may be transmitted using subcarriers arranged at regular intervals in the frequency axis, and subcarriers should be observed on an OFDM grid to maintain orthogonality between the subcarriers at the receiver. However, since the signal received at the mobile terminal is a signal that has undergone the multiple paths and the Doppler spread, the frequency of the signal received at the mobile terminal may be distorted. Therefore, inter-carrier interference (ICI) may occur, and the quality of the received signal may be degraded due to the ICI.

In an uplink transmission procedure, a plurality of terminals having different movement speeds and different movement directions may transmit signals using the same radio resources or adjacent radio resources. In this case, the base station may receive signals causing different frequency dispersion, and interference may occur between the signals received at the base station.

Direct Communication Between Mobile Terminals (e.g., Sidelink Communication)

In a communication system supporting vehicle-to-everything (V2X) communication, direct communication between mobile terminals may be performed. A mobile terminal #1 may acquire time/frequency synchronization by receiving a synchronization signal from the base station, and may perform direct communication with a mobile terminal #2 after acquisition of the time/frequency synchronization. Since a relative speed between the mobile terminal #1 and the base station is different from a relative speed between the mobile terminal #1 and the mobile terminal #2, a frequency of a signal received by the mobile terminal #1 from the mobile terminal #2 may be different from a frequency which the mobile terminal #1 assumes as a frequency of the received signal.

Multi-Point Transmission Scheme

FIG. 3 is a conceptual diagram illustrating frequency dispersion according to a multi-point transmission scheme in a communication system.

Referring to FIG. 3, a communication system may include a transmission/reception point (TRP) 311, a TRP 312, a terminal 320, and the like. The TRP 311 may perform communication using a frequency f₁, and the TRP 312 may perform communication using a frequency f₂. The frequency f₁ may be different from the frequency f₂. That is, a frequency synchronization error may occur between the TRP 311 and the TRP 312. In this case, signals received at the terminal 320 may have different frequencies. Alternatively, even when the frequency f₁ is the same as the frequency f₂, the signals received at the terminal 320 moving at a speed v may have different frequencies due to Doppler shift.

Waveform Robust to Frequency Dispersion

In a communication system supporting the OFDM scheme, when a subcarrier spacing is Δf and a modulation symbol transmitted in a subcarrier fᵢ is denoted as X_{fi}, a transmission signal S_{T}(t) transmitted using N adjacent subcarriers may be defined as in Equation 2.

$${s}_{T} ( t ) = {\sum }_{i = 1}^{i = N} {X}_{{f}_{i}} {e}^{- i 2 π {f}_{i} t} \qquad [ Equation 2 ]$$

The Doppler shift is proportional to a frequency of each of the subcarriers, but if a bandwidth is very small compared to a carrier frequency, the Doppler shift may be assumed to be the same for all subcarriers. In case of ‘f_{c}>>MΔf’, Equation 3 below may be defined. f_{c} may be the center frequency of the frequency band occupied by the subcarriers, and may be x GHz. M may be the number of subcarriers and MΔf may be x MHz. Here, x may be a positive integer.

f_{i,D}=αfᵢ

f_{i,D}=α(f_{c}+iΔf)≈αf_{c} [Equation 3]

When a signal is transmitted over a radio channel, a signal received at the receiver may be ‘signal component S_{R,1} without Doppler shift δf+signal component S_{R,2} with Doppler shift δf’. Also, radio channel coefficients experienced by each of the signal components S_{R,1} and S_{R,2} may be the same regardless of the subcarrier. In this case, the reception signal S_{R}(t) received at the receiver may be defined as in Equation 4 below.

$${s}_{R} ( t ) = {\sum }_{i = 1}^{i = N} A {X}_{{f}_{i}} {e}^{- i 2 π {f}_{i} t} + {BX}_{{f}_{i}} {e}^{- i 2 π ( {f}_{i} + δ f ) t} \qquad [ Equation 4 ]$$

When a M-point fast Fourier transform (FFT) is applied, the received signal S_{R}(fᵢ) in the subcarrier fᵢ of the frequency domain may be defined as in Equation 5 below. Here, M may be greater than or equal to N.

$${S}_{R} ( {f}_{i} ) = \frac{1}{M} {\sum }_{j = 1}^{j = M} {s}_{R} ( {t}_{j} ) {e}^{i 2 π {f}_{i} {t}_{j}} \qquad [ Equation 5 ]$$

Here, fⱼ=(j−1)Δf+f₀ and tⱼ=(j−1)Δt+t₀ may be defined, and a relation of

$$Δ t = \frac{Δ f}{M} = \frac{1}{T M} \qquad$$

may be established. T may be a duration of an OFDM symbol. When the signal component S_{R,1} without Doppler shift is defined as s_{R,1}(t)=Σᵢ₌₁^{i=N} AX_{f}_{ᵢ}e^{-i2πf}^{ᵢ}^{t} and the signal component S_{R,2} with Doppler shift is defined as S_{R,2}(t)=Σᵢ₌₁^{i=N} BX_{f}_{ᵢ}e^{-i2π(f}^{ᵢ}^{δf)t}, the received signal in the frequency domain may be defined as in Equation 6 below.

$${S}_{R , 1} ( {f}_{i} ) = \frac{1}{M} {\sum }_{j = 1}^{j = M} {s}_{1} ( {t}_{j} ) {e}^{i 2 π {f}_{i} {t}_{j }} = {AX}_{{f}_{i}} \\ {S}_{R , 2} ( {f}_{i} ) = \frac{1}{M} {\sum }_{j = 1}^{j = M} {s}_{R , 2} ( {t}_{j} ) {e}^{i 2 π {f}_{i} {t}_{j}} = \frac{1}{M} {\sum }_{j = 1}^{j = M} {\sum }_{k = 1}^{k = N} B {X}_{{f}_{k}} {e}^{- i 2 π ( {f}_{k} - {f}_{i} + δ f ) {t}_{j}} \qquad [ Equation 6 ]$$

S_{R,1}(fᵢ) may be a signal component consisting of only the desired modulation symbol X_{f}_{ᵢ} in the subcarrier fᵢ. S_{R,2}(fᵢ) may be a sum of the desired modulation symbol X_{f}_{ᵢ} in the subcarrier fᵢ and modulation symbols of other subcarriers. That is, S_{R,2}(fᵢ) may be a signal having ICI due to the Doppler effect. In case that (fₖ−fᵢ)>>δf (i≠j), e^{-i2π(f}^{ₖ}^{-f}^{ᵢ}^{+δf)t}^{ⱼ}≈e^{-i2π(f}^{ₖ}^{-f}^{ᵢ}^{)t}^{ⱼ} may be defined, and Equation 7 below may be defined.

$${S}_{R , 2} ( {f}_{i} ) = \frac{1}{M} {\sum }_{j = 1}^{j = M} {\sum }_{k = 1}^{k = N} {BX}_{{f}_{k}} {e}^{- i 2 π ( {f}_{k} - {f}_{i} + δ f ) {t}_{j}} \approx \frac{1}{M} {BX}_{{f}_{i}} {\sum }_{j = 1}^{j = M} ( {e}^{- i 2 π δ f {t}_{j}} - 1 ) + {BX}_{{f}_{i}} \qquad [ Equation 7 ]$$

In Equation 7, fⱼ=(j−1)Δf+f₀ and tⱼ=(j−1)Δt+t₀ may be defined, and

$$Δ t = \frac{Δ f}{M} = \frac{1}{T M}$$

may be established.

Therefore, when the subcarrier spacing is sufficiently large in the communication system supporting the OFDM scheme, ICI due to the Doppler effect may be eliminated. That is, if the relationship between the duration of the OFDM symbol and the Doppler shift satisfies

$$T ≪ \frac{1}{δ f} ,$$

the ICI may be eliminated.

If the same modulation symbol (i.e., X_{f}_{ₖ}=X) is transmitted regardless of the subcarrier, Equation 8 below may be defined.

$${S}_{R , 2} ( {f}_{i} ) = \frac{1}{M} BX {\sum }_{j = 1}^{j = M} {e}^{i 2 π ( {f}_{i} - δ f ) {t}_{j}} {\sum }_{k = 1}^{k = N} {e}^{- i 2 π {f}_{k} {t}_{j}} \qquad [ Equation 8 ]$$

According to Equation 8, S_{R,2}(fᵢ) may include its modulation symbol due to Doppler shift.

Meanwhile, in order to determine an effect of a Discrete Fourier transform (DFT) spreading on the Doppler shift, it is assumed that X_{f}_{ₖ} (k=1, 2, . . . N) is obtained through DFT of D_{τ}_{ₗ} (l=1, 2, . . . , N) defined in Equation 9 below.

$${X}_{{f}_{k}} = \frac{1}{N} {\sum }_{l = 1}^{l = N} {D}_{{τ}_{l}} {e}^{i 2 π {f}_{k} {τ}_{l}} \qquad [ Equation 9 ]$$

fₖ=(k−1)Δf+f₀^{DN} may be defined, τₗ=(l−1)Δτ+t₀, may be defined, and f₀^{DN} may be one of subcarrier frequencies. Also,

$$Δ τ = \frac{Δ f}{N} = \frac{1}{TN}$$

may be established.

In this case, the signal component without the Doppler shift may be defined in Equation 10 below in the frequency domain.

$${S}_{R , 1} ( {f}_{i} ) = \frac{1}{N} A {\sum }_{l = 1}^{l = N} {D}_{{τ}_{l}} {e}^{i 2 π {f}_{i} {τ}_{l}} \qquad [ Equation 10 ]$$

The signal component with the Doppler shift may be defined in Equation 11 below in the frequency domain.

$${S}_{R , 2} ( {f}_{i} ) = \frac{1}{M} {\sum }_{j = 1}^{j = M} {\sum }_{k = 1}^{k = N} B {X}_{{f}_{k}} {e}^{- i 2 π ( {f}_{k} - {f}_{i} + δ f ) {t}_{j}} \\ {S}_{R , 2} ( {f}_{i} ) = \frac{1}{M N} B {\sum }_{j = 1}^{j = M} {e}^{i 2 π ( {f}_{i} - δ f ) {t}_{j}} {\sum }_{k = 1}^{k = N} {\sum }_{n = 1}^{n = N} {D}_{{τ}_{n}} {e}^{i 2 π {f}_{r} {τ}_{n}} {e}^{- i 2 π {t}_{j} {f}_{k}} \qquad [ Equation 11 ]$$

In this case, when an N-point inverse DFT (IDFT) is applied, the signal component without Doppler shift may be defined as in Equation 12 below.

$${O}_{1 n} = {\sum }_{i = 1}^{i = N} {S}_{R , 1} ( {f}_{i} ) {e}^{- i 2 π {f}_{i} {τ}_{n}} \\ {O}_{1 n} = \frac{1}{N} A {\sum }_{i = 1}^{i = N} {\sum }_{l = 1}^{l = N} {D}_{{τ}_{l}} {e}^{i 2 π {f}_{i} {τ}_{l}} {e}^{- i 2 π {f}_{i} {τ}_{n}} = {AD}_{{τ}_{n}} \qquad [ Equation 12 ]$$

When the N-point IDFT is applied, the signal component with Doppler shift may be defined as in Equation 13 below.

$${S}_{R , 2} ( {f}_{i} ) = \frac{1}{M N} B {\sum }_{j = 1}^{j = M} {e}^{i 2 π ( {f}_{i} - δ f ) {t}_{j}} {\sum }_{k = 1}^{k = N} {\sum }_{l = 1}^{l = N} {D}_{{τ}_{l}} {e}^{i 2 π {f}_{{k}^{τ} l}} {e}^{- i 2 π {t}_{j} {f}_{k}} \\ {O}_{2 n} = {\sum }_{i = 1}^{i = N} {S}_{R , 2} ( {f}_{i} ) {e}^{- i 2 π {f}_{i} {τ}_{n}} \\ {O}_{2 n} = \frac{1}{M N} {\sum }_{i = 1}^{i = N} B {\sum }_{j = 1}^{j = M} {e}^{i 2 π ( {f}_{i} - δ f ) {t}_{j}} {\sum }_{k = 1}^{k = N} {\sum }_{l = 1}^{l = N} {D}_{{τ}_{l}} {e}^{i 2 π {f}_{k} {τ}_{l}} {e}^{- i 2 π {f}_{k} {t}_{j}} {e}^{- i 2 π {f}_{i} {τ}_{n}} \\ {O}_{2 n} = \frac{1}{M N} {\sum }_{i = 1}^{i = N} B {\sum }_{j = 1}^{j = M} {e}^{i 2 π ( {f}_{i} - δ f ) {t}_{j}} {\sum }_{k = 1}^{k = N} {\sum }_{l = 1}^{l = N} {D}_{{τ}_{l}} {e}^{i 2 π {f}_{k} ( {τ}_{l} - {t}_{j} )} {e}^{- i 2 π {f}_{i} {τ}_{n}} \qquad [ Equation 13 ]$$

When M=N and f₀=f₀^{DN}, Equation 14 below may be defined.

$${O}_{2 n} = \frac{1}{M} {\sum }_{i = 1}^{i = N} B {\sum }_{j = 1}^{j = M} {D}_{{τ}_{j}} {e}^{i 2 π ( {f}_{i} - δ f ) {t}_{j}} {e}^{- i 2 π {f}_{i} {τ}_{n}} \\ {O}_{2 n} = B {e}^{- i 2 π ( δ f ) {τ}_{n}} {D}_{{τ}_{n}} \qquad [ Equation 14 ]$$

In this case, a signal obtained after the N-point IDFT may be defined as in Equation 15 below.

Oₙ=(A+Be^{-i2π(δf)τ}^{ₙ})D_{τ}_{ₙ} [Equation 15]

That is, there may be no interference between the modulation symbols D_{τ}_{ₙ}. When the same frequency axis response is caused by the radio channels experienced by all subcarriers through which the modulation symbols are transmitted irrespective of the duration of the OFDM symbol (i.e., a case of flat fading channel), the ICI due to the Doppler effect May not occur.

Meanwhile, when M=QN and tⱼ=τₙ, Equation 16 below may be defined. Q may be a positive integer (e.g., 1, 2, 3, etc.).

$${\sum }_{i = 1}^{i = N} {e}^{- i 2 π {f}_{i} ( {τ}_{n} - {t}_{j} )} = N \qquad [ Equation 16 ]$$

On the other hand, when M=QN and tⱼ≠τₙ, Equation 17 below may be defined.

$${\sum }_{i = 1}^{i = N} {e}^{- i 2 π {f}_{i} ( {τ}_{n} - {t}_{j} )} \approx 0 \qquad [ Equation 17 ]$$

From Equation 17, Equation 18 below may be defined.

Oₙ≈(A+Be^{-i2π(δf)τ}^{ₙ})D_{τ}_{ₙ} [Equation 18]

That is, according to Equation 18, there may be little interference between the modulation symbols D_{τ}_{ₙ}.

On the other hand, even when (M=QN) is not satisfied, if Σᵢ₌₁^{i=N} e^{-i2πfi(τ}^{ₙ}^{-t}^{ⱼ}⁾≈Nδ_{τ}_{ₙ}_{,t}_{ⱼ} is assumed, Equation 19 below may be defined.

$${O}_{2 n} \approx {Be}^{i 2 π ( - δ f ) {τ}_{n}} {\sum }_{k = 1}^{k = N} {\sum }_{l = 1}^{l = N} {D}_{{τ}_{l}} {e}^{i 2 π {f}_{k} ( {τ}_{l} - {τ}_{n} )} = {Be}^{- i 2 π ( δ f ) {τ}_{n}} {D}_{{τ}_{n}} \qquad [ Equation 19 ]$$

According to Equation 19, Equation 20 below may be defined.

O₂ₙ≈Be^{-i2π(δf)τ}^{ₙ}D_{τ}_{ₙ} [Equation 20]

According to Equation 20, a signal obtained after the N-point IDFT may be defined as Equation 21 below.

Oₙ≈(A+Be^{-i2π(δf)τ}^{ₙ})D_{τ}_{ₙ} [Equation 21]

Even if the duration of the OFDM symbol is not shortened, the signal to which DFT spreading is applied may be robust to the Doppler shift. In particular, when (M=QN) is satisfied, the interference between modulation symbols D_{τ}_{ₙ} can be greatly reduced. When (M=QN) is not satisfied, Σᵢ₌₁^{i=N} e^{-i2πf}^{ᵢ}^{(τ}^{ₙ}^{-t}^{ⱼ}⁾≈δ_{τ}_{ₙ}_{,t}_{ⱼ} may be applied more accurately, and thus the corresponding signal may be robust to the Doppler shift. Since the DFT spreading is applied to exhibit a single carrier characteristic, the overlap between adjacent symbols in the time domain may not be large, and interference between the symbols due to frequency dispersion may be reduced.

Multi-DFT Spreading Scheme

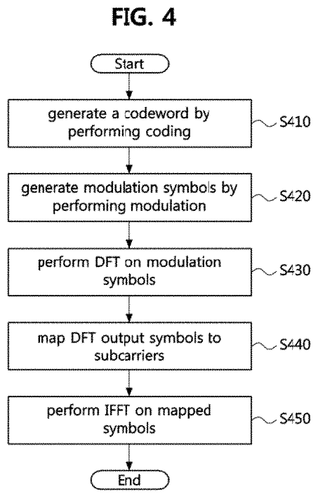

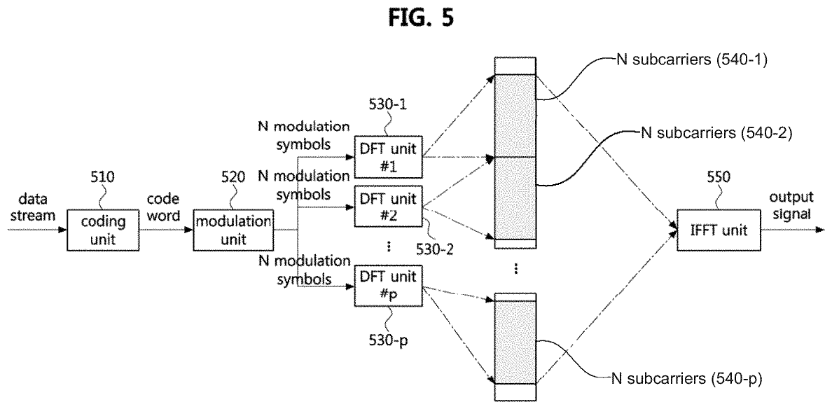

FIG. 4 is a flowchart illustrating a first exemplary embodiment of a signal transmission method based on a multi-DFT spreading scheme in a communication system, and FIG. 5 is a conceptual diagram for explaining the exemplary embodiment of FIG. 4.

Referring to FIGS. 4 and 5, a communication node (e.g., a base station or a terminal) may transmit a signal based on a multi-DFT spreading scheme. In the multi-DFT spreading scheme, DFT spreading may be applied in units of one or more resource blocks. The DFT spreading unit may be determined according to the amount of resources used for transmission. The size of the resource blocks, which is the DFT spreading unit, may be configured such that the radio channel coefficients have constant values. The communication node may include a coding unit 510, a modulation unit 520, a plurality of N-point DFT units 530-1, 530-2, . . . , and 530-p, a mapper (not shown), and an M-point inverse FFT (IFFT) unit 550. Here, p may be an integer of 1 or more.

Here, the unit may mean a means for performing the corresponding function or operation. The operations performed by the coding unit 510, the modulation unit 520, the plurality of N-point DFT units 530-1, 530-2, . . . , and 530-p, the mapper, and the M-point IFFT unit 550 may be performed by a processor (e.g., processor 210 of FIG. 2) included in the communication node.

When M=2K, ‘N=2L (L≤K)’ may be defined. L may be known to the communication nodes in advance. Alternatively, the base station among the communication nodes may set L, and may transmit a messaged including L to a terminal, which is another communication node. N, which is a unit of DFT spreading, may be set sufficiently small so that the difference in frequency responses of the radio channels experienced by N subcarriers is not large between subframes.

The communication node may generate a codeword by performing coding on a data stream (S410). The communication node may generate modulation symbols by performing modulation on the codeword (S420). N modulation symbols may be input to each of the plurality of N-point DFT units 530-1, 530-2, . . . , and 530-p. That is, the communication node may generate N output symbols (e.g., frequency domain signals) by performing DFT on N modulation symbols (S430).

The communication node may map outputs of each of the N-point DFT units 530-1, 530-2, . . . , and 530-p to N consecutive subcarriers (S440). The step S440 may be performed by a mapper included in the communication node. For example, the outputs of the N-point DFT unit 530-1 may be mapped to N consecutive subcarriers 540-1, the outputs of the N-point DFT unit 530-2 may be mapped to N consecutive subcarriers 540-2, and the outputs of the N-point DFT unit 530-p may be mapped to N consecutive subcarriers 540-p.

After the resource mapping is completed, the communication node may generate a time domain signal by performing IFFT on the frequency domain signals (i.e., the output signals of the DFT units) (S450). The time domain signal may be transmitted through a radio frequency (RF) module of the communication node.

When the DFT spreading and the IFFT are performed, modulation symbols spread in a DFT spreading region—may be sequentially located in the time axis. When multi-DFT spreading is applied, the signal has a single carrier characteristic, and since the overlap between adjacent symbols is not large in the time domain, interference between symbols due to frequency dispersion may be reduced.

When the DFT spreading unit is narrow in the frequency axis, the change of the channel coefficients in the frequency axis is not large, and in this case, the modulation symbols may be orthogonal to each other even when subjected to Doppler shift. However, although ICI may exist between a subcarrier located at the edge of the DFT spreading region and an adjacent subcarrier, since interference is reduced as the frequency difference between the subcarriers increases, the interference caused by the ICI to the spread modulation symbols may not be so large.

On the other hand, the transmission signal according to the exemplary embodiments shown in FIGS. 4 and 5 may be processed in the receiver as follows.

Reception Scheme Robust to Frequency Dispersion

When a signal transmitted from a single TRP is received at a receiver through a radio channel having multiple paths, the signal received at the receiver may have different Doppler shifts with respect to reception directions. That is, the reception signal may be a signal having Doppler spread. In a communication scheme using multiple TRPs, a main component of the reception signal may be a line of sight (LOS) signal, and signals received from different TRPs may have different Doppler shifts.

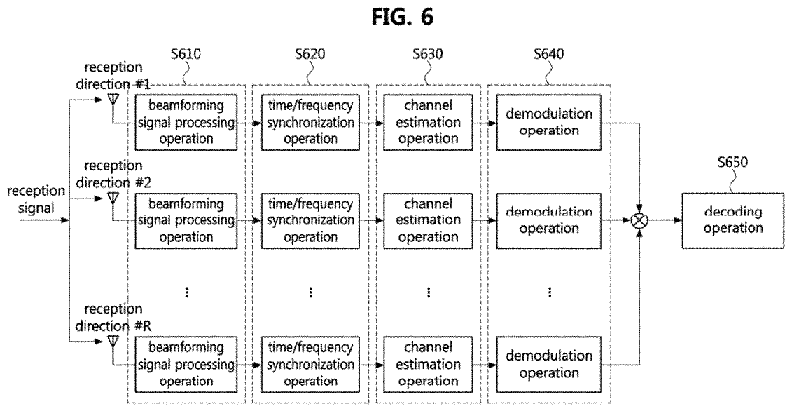

FIG. 6 is a conceptual diagram for explaining a first exemplary embodiment of a method of receiving a signal in a communication system.

Referring to FIG. 6, a transmission signal may be transmitted based on the OFDM scheme (e.g., multi DFT spreading scheme). A communication node may separate the Doppler shifted signals by performing a separate reception processing operation for each receiving direction (e.g., receiving direction #1, receiving direction #2, . . . , receiving direction # R). R may be an integer of 3 or more. Here, the communication node may include a linear antenna array as follows.

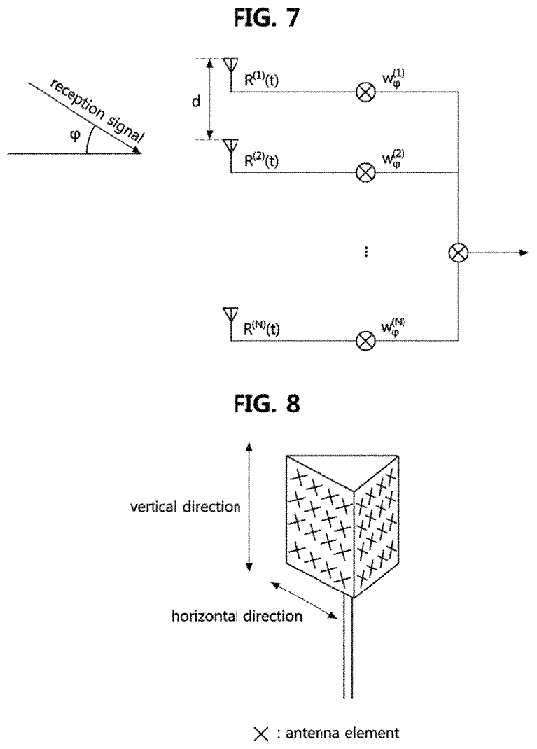

FIG. 7 is a conceptual diagram illustrating a first exemplary embodiment of a linear antenna array included in a communication node.

Referring to FIG. 7, the linear antenna array of the communication node may include N antenna elements, and the spacing between the antenna elements may be d. The receiving direction of each of the N antenna elements may be preconfigured.

Referring back to FIG. 6, the communication node may perform a beamforming signal processing operation on signals received in the respective receiving directions #1 to # R (S610). The step S610 may be performed based on a digital signal processing scheme or an analog signal processing scheme.

Digital Signal Processing Scheme

When the communication node includes the N antenna elements shown in FIG. 7, the communication node may add signals obtained by multiplying

$${w}_{ϕ}^{( n )} = {e}^{i \frac{2 π}{λ} d ( n - 1 ) s i n ( ϕ )}$$

to the signal received at the reception antenna element # n so as to extract a signal having an angle of incidence φ for the signal R⁽ⁿ⁾ (t) received at the antenna array. n may be a value from 1 to N, and λ may be a wavelength of the carrier frequency.

Analog Signal Processing Scheme

When the analog signal processing scheme is used, each of the N antenna elements shown in FIG. 7 may be designed to have a large channel gain for a specific receiving direction.

When the step S610 is completed, the communication node may acquire time/frequency synchronization for each of the receiving directions #1 to # R by using the signal obtained in the step S610 (S620). Also, the communication node may perform channel estimation for each of the receiving directions #1 to # R (S630), and perform demodulation on the signal received in each of the receiving directions #1 to # R based on the channel estimation results (S640). The communication node may combine demodulation symbols of the respective receiving directions #1 to # R, and perform a decoding operation on the combined demodulation symbols (S650).

On the other hand, the exemplary embodiment shown in FIG. 6 may be performed by a communication node including a two-dimensional antenna array.

FIG. 8 is a conceptual diagram illustrating a first exemplary embodiment of a two-dimensional antenna array included in a communication node.

Referring to FIG. 8, a two-dimensional antenna array of a communication node may include a plurality of antenna elements. The plurality of antenna elements may be arranged at regular intervals in the horizontal axis, and the plurality of antenna elements may be arranged at regular intervals in the vertical axis.

The communication node may perform the steps shown in FIG. 6 using the antenna elements in the horizontal and/or vertical direction. The communication node may acquire a signal by performing a beamforming signal processing operation that increases a channel gain of signal components for each of one or more preconfigured receiving directions. The communication node may perform a time/frequency synchronization operation, a channel estimation operation, and a demodulation operation on the signal in each of the receiving directions. The communication node may combine demodulation symbols that are output from the demodulation operations in the respective receiving directions, and perform a decoding operation on the combined demodulation symbols.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a first communication node in a communication system, the operation method comprising:
generating a codeword by performing coding on a data stream;
generating modulation symbols by performing modulation on the codeword;
performing discrete Fourier transform (DFT) on N modulation symbols among the modulation symbols by using a plurality of DFT units;
mapping output symbols of each of the plurality of DFT units to a resource; and
performing inverse fast Fourier transform (IFFT) on the output symbols mapped to the resource by using an IFFT unit,
wherein N is a positive integer.

2. The operation method according to claim 1, wherein the N modulation symbols are spread in a frequency axis by the plurality of DFT units, and the spreading by the plurality of DFT units is performed in units of one or more resource blocks.

3. The operation method according to claim 1, wherein each of the plurality of DFT units is an N-point DFT unit.

4. The operation method according to claim 3, wherein the IFFT unit is an M-point IFFT unit, M is 2^{K}, N is 2^{L}, L is less than or equal to K, and each of M, K and L is a positive integer.

5. The operation method according to claim 4, wherein L is configured by a second communication node, and a signaling message indicating L is received from the second communication node.

6. The operation method according to claim 1, wherein the N output symbols of each of the plurality of DFT units are mapped to consecutive N subcarriers.

7. The operation method according to claim 1, wherein output symbols of the IFFT unit are located sequentially in a time axis.

8. A first communication node in a communication system, the first communication node comprising:
a coding unit generating a codeword by performing coding on a data stream;
a modulation unit generating modulation symbols by performing modulation on the codeword;
a plurality of discrete Fourier transform (DFT) units performing DFT on N modulation symbols among the modulation symbols;
a mapper mapping output symbols of each of the plurality of DFT units to a resource; and
an inverse fast Fourier transform (IFFT) unit performing IFFT on the output symbols mapped to the resource.

9. The first communication node according to claim 8, wherein the N modulation symbols are spread in a frequency axis by the plurality of DFT units, and the spreading by the plurality of DFT units is performed in units of one or more resource blocks.

10. The first communication node according to claim 8, wherein each of the plurality of DFT units is an N-point DFT unit.

11. The first communication node according to claim 10, wherein the IFFT unit is an M-point IFFT unit, M is 2^{K}, N is 2^{L}, L is less than or equal to K, and each of M, K and L is a positive integer.

12. The first communication node according to claim 11, wherein L is configured by a second communication node, and a signaling message indicating L is received from the second communication node.

13. The first communication node according to claim 8, wherein the N output symbols of each of the plurality of DFT units are mapped to consecutive N subcarriers.
